(19) United States
(12) Patent Application Publication
(10) Pub. No.: US 2010/0179757 A1
(43) Pub. Date: Jul. 15, 2010

(54) POSITIONING DEVICE AND POSITION MEASUREMENT INTERVAL CONTROL METHOD

(75) Inventors: Naoki Iketani, Kanagawa (JP); Kenta Cho, Tokyo (JP); Masanori Hattori, Kanagawa (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/560,613

(22) Filed: Sep. 16, 2009

(30) Foreign Application Priority Data
Jan. 15, 2009 (JP) 2009-006833

(51) Int. Cl. G01C 21/00; G01S 19/41

(52) U.S. Cl. 701/214; 342/357.09; 342/357.03

(57) ABSTRACT

A portable terminal includes a body movement sensor configured to detect a movement of a user; a normal moving pattern storage unit configured to store, in advance, a normal moving pattern; a moving state determination unit configured to determine the moving state from the movement; a normal moving certainty calculation unit configured to calculate a normal moving certainty indicating a degree of coincidence between the normal moving pattern and the moving state determined at time of detecting the movement; a position measurement interval controller configured to calculate a position measurement interval depending on the normal moving certainty; and a positioning unit configured to measure a current position of the portable terminal at the position measurement interval.

### CROSS-REFERENCE TO RELATED APPLICATIONS

This application is based upon and claims the benefit of priority from the prior Japanese Patent Application No. 2009-006833, filed on Jan. 15, 2009; the entire contents of which are incorporated herein by reference.

### BACKGROUND OF THE INVENTION

1. Field of the Invention

The present invention relates to a positioning device and a position measurement interval control method using a GPS (Global Positioning System) or the like for measuring a current position.

2. Description of the Related Art

In recent years, various types of devices using a function of determining their positions by receiving radio waves from a GPS satellite (so-called GPS function) are disclosed. For example, JP-A 2008-46674 (KOKAI) discloses the following technique. If an information terminal device moves on a moving route stored in advance, the information terminal device measures its position using a position determination function (GPS function). If the information terminal device deviates from the moving route, that is, if the information terminal device is away from the moving route by a predetermined distance or longer, the information terminal device informs a predetermined contact address of the deviation and outputs a direction for returning to the moving route.

With such a technique, the information terminal device measures longitude and latitude of the current position using the GPS function at an interval of preset calculation time period. Due to this, even if the current position does not deviate from the moving route, the information terminal device regularly measures its position. However, because of excessive power consumption for position detection using the GPS function, it is desirable to reduce power consumption, for example, by restricting use of the GPS function when a small-sized portable terminal such as a mobile telephone detects and records position movement of a user thereof in a day.

To satisfy the demand, JP-A H11-132786 discloses the following portable velocity and distance meter. In the velocity and distance meter, a body movement detection sensor (an acceleration sensor or a gyroscope) detects a moving state of its user during walking or running and if the moving state of the user changes and it is necessary to measure a position thereof, a GPS receiver is turned on for a predetermined time period. When the predetermined time period elapses, the GPS receiver is turned off and then a moved velocity and a moved distance of the user are calculated for power saving.

However, the conventional portable velocity and distance meter has the following problems. At normal time, a user hardly keeps a constant velocity since the user is possibly in various moving states including walking, running and getting on a train. Due to this, if the technique of the portable velocity and distance meter for determining a position by turning on the GPS receiver when the moving state of the user who is walking or running changes is applied to user's daily life, the meter always measures the position of the user using the GPS function. This results in excessive power consumption of the meter and makes it impossible to realize power saving.

### SUMMARY OF THE INVENTION

According to an aspect of the present invention, a positioning device includes a detection unit configured to detect a movement of a user who owns the positioning device; a storage unit configured to store, in advance, a normal moving pattern indicating a temporal change in a moving state of the user at normal time; a determination unit configured to determine the moving state from the movement; a first certainty calculation unit configured to calculate a first certainty indicating a degree of coincidence between the normal moving pattern and the moving state determined at time of detecting the movement; an interval calculation unit configured to calculate a position measurement interval depending on the first certainty; and a positioning unit configured to measure a current position of the positioning device at the position measurement interval.

According to another aspect of the present invention, a position measurement interval control method includes detecting a movement of a user who owns a positioning device; determining a moving state of the user who owns the positioning device from the movement; calculating a first certainty indicating a degree of coincidence between the normal moving pattern and the moving state determined at time of detecting the movement; calculating a position measurement interval depending on the first certainty; and measuring a current position of the positioning device at the position measurement interval.

### BRIEF DESCRIPTION OF THE DRAWINGS

FIG. 1 is an external configuration diagram showing an example of a portable terminal;

FIG. 2 is a block diagram showing an example of a functional configuration of the portable terminal;

FIG. 3 is a table showing an example of a threshold table;

FIG. 4 is a table showing an example of a normal moving pattern;

FIG. 5 is a flowchart showing a flow of a position measurement interval control processing performed by the portable terminal;

FIG. 6 is a block diagram showing an example of a functional configuration of a portable terminal; and

FIG. 7 is a flowchart showing a flow of a position measurement interval control processing performed by the portable terminal.

### DETAILED DESCRIPTION OF THE INVENTION

A positioning device and a position measurement interval control method according to preferred embodiments of the present invention will be described hereinafter with reference to the accompanying drawings. In embodiments below, an example of applying the positioning device according to the embodiment to a portable terminal such as a mobile telephone or a PDA (personal digital assistance) is described. However, application of the embodiment is not limited to the example. The embodiment is applicable to an arbitrary device as long as the device can incorporate therein a positioning function.

### First Embodiment

The portable terminal according to a first embodiment of the present invention records a daily moving history for every user, creates a normal moving pattern that is a combination of time, a position, a moving state, and stores one or more of the created moving pattern. When the portable terminal is to measure its current position, the portable terminal determines the moving state of its user using a body movement sensor that operates with lower power consumption than a GPS function, and determines whether or not the user acts according to the normal moving pattern. If the user acts according to the normal moving pattern, the portable terminal estimates that the user is located at a position corresponding to the normal moving pattern based on the moving state and the time without determining the current position using the GPS function. If the user acts without following the normal moving pattern, the portable terminal measures the current position using the GPS function. This derives from a concept that a user often follows a repetitive pattern of, for example, moving between a few specific locations if a daily movement of the user is captured macroscopically.

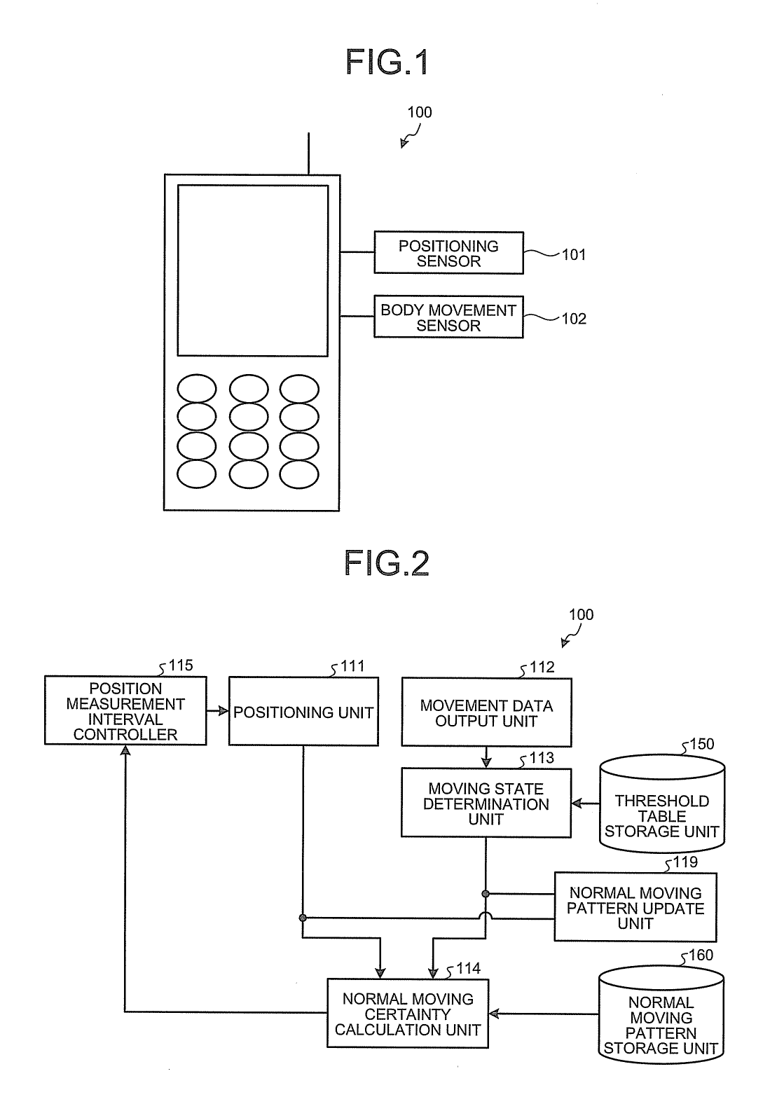

As shown in FIG. 1, at least one positioning sensor 101 and at least one body movement sensor 102 are connected to one portable terminal 100.

The positioning sensor 101 is a sensor that receives radio waves from a GPS satellite at a position measurement interval determined by a position measurement interval controller 115, to be described later, so as to measure a current position of the portable terminal 100. In this embodiment, the GPS function is used as a typical configuration of the positioning sensor 101. However, position measurement is not limited to the GPS function-based measurement. If the portable terminal 100 is, for example, a mobile telephone, the positioning sensor 101 may be configured to function as an antenna that receives radio waves from a communication base station, to measure its position by identifying the communication base station that has transmitted the radio waves received by the positioning sensor 101. Alternatively, the positioning sensor 101 can also be configured to function as an antenna that receives radio waves from an access point on a wireless LAN (Local Area Network), to measure its position by identifying the access point that has transmitted the radio waves received by the positioning sensor 101.

The body movement sensor 102 is a sensor that detects a movement of a user who owns the portable terminal 100 at an interval of certain time period. In this embodiment, an acceleration sensor that detects the movement of the user using a triaxial accelerometer is used as a typical configuration of the body movement sensor 102. However, the body movement sensor 102 is not limited to the acceleration sensor. The body movement sensor 102 may be configured using, for example, a gyroscope or an azimuth sensor.

In as another alternative, the body movement sensor 102 may be configured not to detect the movement of the user using the triaxial acceleration but configured with a microphone, a camera or the like, to detect the body movement of the user who owns the portable terminal 100 by estimating the movement of the user based on an audio signal from the microphone or an imaging signal from the camera with certain accuracy.

As shown in FIG. 1, the portable terminal 100 according to this embodiment is configured in such a manner that the positioning sensor 101 and the body movement sensor 102 are connected to a main body of the portable terminal 100. However, the configuration of the portable terminal 100 is not limited to that shown in FIG. 1. The portable terminal 100 can be configured, for example, to include the positioning sensor 101 and the body movement sensor 102 in its main body. Alternatively, the portable terminal 100 may be configured in such a manner that the positioning sensor 101 and the body movement sensor 102 are provided at non-contact positions at which the sensors 101 and 102 do not contact with the main body of the portable terminal 100, and the portable terminal 100 receives signals detected by the positioning sensor 101 and the body movement sensor 102 through wireless communication. While an example in which one user uses the portable terminal 100 is described in this embodiment, the present invention is not limited to this example. The present invention is applicable to a usage form in which a plurality of users uses one portable terminal.

As shown in FIG. 2, the portable terminal 100 mainly includes a positioning unit 111, a movement data output unit 112, a moving state determination unit 113, a threshold table storage unit 150, a normal moving certainty calculation unit 114, a normal moving pattern storage unit 160, the position measurement interval controller 115 and a normal moving pattern update unit 119. The portable terminal 100 according to the first embodiment includes, as a hardware configuration, a CPU and storage mediums such as a HDD (hard disk drive) and a memory, all of which are not shown.

The positioning unit 111 measures the current position of the portable terminal 100 based on radio waves received by the positioning sensor 101 from the GPS satellite.

If the body movement sensor 102 detects the movement (body movement) of the user who owns the portable terminal 100, the movement data output unit 112 outputs movement data indicating the detected movement. In this embodiment, the movement data output unit 112 outputs a triaxial acceleration vector as the movement data since the acceleration sensor is used as the body movement sensor 102.

The moving state determination unit 113 determines a moving state of the user who owns the portable terminal 100 from the movement data output from the movement data output unit 112. The moving state means herein a specific state of moving of the user who owns the portable terminal 100. Examples of the moving state include “rest”, “train”, “car”, “walking”, “bicycle” and “running”. That is, the moving state “rest” indicates that the user is not moving but is at rest. The moving states “train”, “car” and “bicycle” indicate that the user is moving by train, by car such as a motor vehicle or a bus and by bicycle, respectively. The moving state “walking” indicates that the user is moving while walking and the moving state “running” indicates that the user is moving while running. It is to be noted that these moving states are given as illustrative purposes and that arbitrary moving states can be set for possible movements of the user.

A method of determining the moving state executed by the moving state determination unit 113 will be described in detail. The moving state determination unit 113 determines the moving state depending on an average fluctuation range within certain time based on the fact that intensity of vibration of the portable terminal 100 changes depending on a moving pattern of the user. Specifically, first, the moving state determination unit 113 calculates a first average value ave_a(t) of an acceleration vector a(t) that temporally changes for certain time period j using the following Equation (1), where the acceleration vector a(t) is a triaxial acceleration output from the movement data output unit 112. In the Equation (1), t represents time.

$$ave\_a ( t ) = {\sum }_{i = t}^{t - j} a / j \qquad ( 1 )$$

The moving state determination unit 113 calculates a second average value |L(t)| by dividing, by certain time period k, a magnitude of a vector obtained by subtracting the first average value ave_a(t) of the acceleration vector a(t) for the certain time period j from the acceleration vector a(t) at each time using the following Equation (2). It is to be noted that the certain time period k is longer than the certain time period j.

$$\vert L ( t ) \vert = {\sum }_{i = t}^{t - j} ( \vert a ( t ) - ave\_a ( t ) \vert ) / k \qquad ( 2 )$$

Furthermore, the moving state determination unit 113 determines the moving state of the user by referring to the second average value |L(t)| and a threshold table.

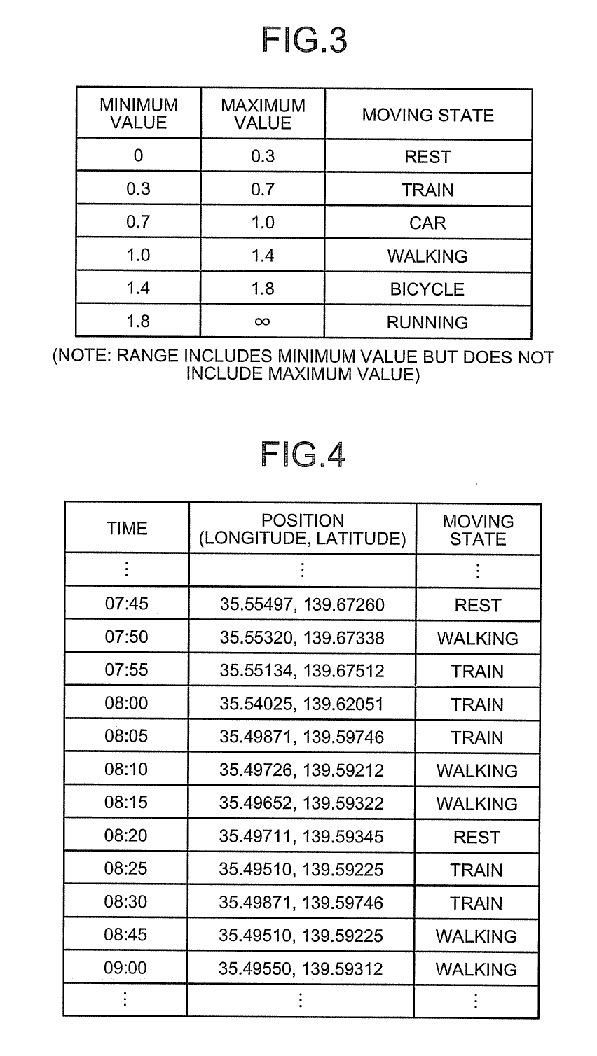

The threshold table will now be described. The threshold table is a table in which the second average value |L(t)| is made to correspond to the moving state of the user for determining the moving state corresponding to the calculated second average value |L(t)| as a current moving state. The threshold table storage unit 150 is a storage medium such as a HDD or a memory storing therein the threshold table. As shown in FIG. 3, ranges each from a minimum value to a maximum value of the second average value |L(t)| and the moving states are registered in the threshold table while each range corresponding to one moving state.

The moving state determination unit 113 determines the moving state corresponding to the range from the minimum value to the maximum value including the calculated second average value |L(t)| as the current moving state by referring to the threshold table shown in FIG. 3. For example, when the calculated second average value |L(t)| is 0.4, the value 0.4 is included in the range in a second block of the threshold table, that is, the range that is equal to or higher than 0.3, which is the minimum value, and less than 0.7, which is the maximum value. Therefore, the moving state determination unit 113 determines that the current moving state of the user is the moving state “train” that is the moving state corresponding to this range. It is to be noted that maximum values and minimum values can be arbitrarily set in advance depending on the movements in the moving states.

The normal moving pattern storage unit 160 is a storage medium such as a HDD or a memory storing therein a normal moving pattern indicating a temporal change in the moving state of the user at normal time. As shown in FIG. 4, in the normal moving pattern, time and a position (a longitude and a latitude) are made to correspond to one of the moving states. In addition, the normal moving pattern storage unit 160 stores different normal moving patterns for each of users. This normal moving pattern means a list of positions frequently measured in a certain time zone. Therefore, only one position (location) is not always made to correspond to one time but a plurality of positions may be made to correspond one time. Further, in the normal moving pattern shown in FIG. 4, the position and the moving state are made to correspond to each time. Further, the normal moving pattern may be configured for each day of the week. This is because it is considered that a person's (user's) movement often has periodicity specific to every day of the week.

Meanwhile, the body movement sensor 102 detects the movement of the user at an interval of certain time period and the moving state determination unit 113 determines the moving state at an interval of certain time period, accordingly. Due to this, the moving state can be obtained as time elapses. The normal moving certainty calculation unit 114 calculates a normal moving certainty p indicating a degree of coincidence between the moving state at a time the body movement sensor 102 detects the movement of the user and the normal moving pattern from a temporal change in the moving state of the user determined by the moving state determination unit 113 and the normal moving pattern stored in the normal moving pattern storage unit 160. A simple method for calculation of the certainty p is as follows. If the moving state determined by the moving state determination unit 113 coincides with the moving state corresponding to the time of detecting the movement of the user in the normal moving pattern, the normal moving certainty calculation unit 114 determines the normal certainty p as “1”. If they do not coincide, the normal moving certainty calculation unit 114 determines the normal certainty p as “0”. Actually, however, it is useful to make more detailed determination.

Accordingly, the normal moving certainty calculation unit 114 according to this embodiment uses the following method.

First, a temporal discrete series b(t) of the moving state is expressed as the following Equation (3), where t is current time.

b(t)=b₀,b₁, . . . bₜ₋₁,bₜ (3)

Furthermore, a moving state series m(t) in the normal moving pattern is expressed as the following Equation (4).

m(t)=m₀,m₁, . . . , mₜ₋₁,mₜ,mₜ₊₁, (4)

The normal moving certainty calculation unit 114 calculates a maximum value n that satisfies the following Equations (5) as maximum coincidence time period for which the determined moving state coincides with the normal moving pattern using the discrete series b(t) expressed by the Equation (3), the moving state series m(t) expressed by the Equation (4) and a predetermined time difference td. In this case, when calculating the maximum value n that satisfies the Equations (5), the normal moving certainty calculation unit 114 refers to the normal moving pattern stored in the normal moving pattern storage unit 160.

$$\begin{matrix}\begin{matrix}\begin{matrix}{b}_{t} = {m}_{t + td} \\ {b}_{t - 1} = {m}_{t + td - 1}\end{matrix} \\ ⋮\end{matrix} \\ {b}_{t - n} = {m}_{t + d - n}\end{matrix} \} \qquad ( 5 )$$

At this time, as expressed by the following Equation (6), an absolute value of the time difference td is assumed to be smaller than a preset allowable maximum time difference tdₘₐₓ.

|td|<tdₘₐₓ (6)

The normal moving certainty calculation unit 114 calculates the normal moving certainty p using preset time period t_{suf} as expressed by the following Equation (7) so as to determine whether or not the determined moving state coincides with the normal moving pattern.

$$p = \{ \begin{matrix}0 & ( n = 0 ) \\ 1 & n > {t}_{suf} \\ else & n / {t}_{suf}\end{matrix} \} \qquad ( 7 )$$

As expressed by the Equation (7), if n=0, that is, if there is no coincidence time period n between the moving state and the normal moving pattern, the normal moving certainty p is zero, that is, p=0 and is the lowest value. If n>t_{suf}, that is, the coincidence time period n between the moving state and the normal moving pattern is longer than the preset time period t_{suf}, the normal moving certainty p is 1, that is, p=1 and is the highest value. If the coincidence time period n between the moving state and the normal moving pattern is longer than 0 and equal to or shorter than the preset time period t_{suf}, the normal moving certainty p changes depending on values of the coincidence time period n between the moving state and the normal moving pattern and the time period t_{suf} as expressed by the Equation (7). More specifically, in this case, as can be seen from the Equation (7), the longer the coincidence time period n between the moving state and the normal moving pattern is, the higher the value of the normal moving certainty p becomes.

The position measurement interval controller 115 calculates a position measurement interval for the position measurement performed by the positioning unit 111 depending on the normal moving certainty p calculated by the normal moving certainty calculation unit 114. More specifically, the position measurement interval controller 115 calculates a position measurement interval to be longer as the value of the normal moving certainty p is higher. That is, as the degree of coincidence between the moving state determined based on the movement data output from the movement data output unit 112 and the normal moving pattern is higher and the value of the normal moving certainty p is higher, it is more probable that the user is moving according to the normal moving pattern, and thus, the position measurement interval controller 115 lengthens the position measurement interval for the position measurement, which consumes relatively high power, performed by the positioning unit 111 to decrease the pace of the operation.

On the other hand, as the degree of coincidence between the moving state determined by the moving state determination unit 113 and the normal moving pattern is lower and the value of the normal moving certainty p is lower, it is more probable that the user is moving without following the normal moving pattern, and thus, the position measurement interval controller 115 shortens the position measurement interval for the position measurement performed by the positioning unit 111 to increase the pace of the operation.

Specifically, the position measurement interval controller 115 calculates a time interval to next position measurement (position measurement interval) tₙₑₓₜ using the normal moving certainty p according to the following Equation (8).

tₙₑₓₜ=p*(tₘₐₓ−tₘᵢₙ)+tₘᵤₙ (8)

In the Equation (8), tₘₐₓ represents a maximum position measurement interval that is a longest position measurement interval for the position measurement performed by the positioning unit 111 and tₘᵢₙ represents a minimum position measurement interval that is a shortest position measurement interval for the position measurement performed by the positioning unit 111. That is, as expressed by the Equation (8), the position measurement interval controller 115 calculates the time interval to the next position measurement (position measurement interval) tₙₑₓₜ by multiplying a difference between the maximum position measurement interval tₘₐₓ and the minimum position measurement interval tₘᵢₙ by the normal moving certainty p and adding the multiplication result to the minimum position measurement interval tₘᵢₙ.

The position measurement interval controller 115 sets a time when the calculated position measurement interval tₙₑₓₜ is to elapse from current time in the memory or the like as position measurement time. When there comes the position measurement time set in the memory or the like, the positioning sensor 101 and the positioning unit 111 start position measurement to receive radio waves from the GPS satellite and the positioning unit 111 measures the current position of the portable terminal 100.

The normal moving pattern update unit 119 updates the normal moving pattern stored in the normal moving pattern storage unit 160. The normal moving pattern update unit 119 stores all histories of positions corresponding to data of each time in the normal moving pattern as a position list and updates the normal moving pattern using an average position of the position list. That is, when the moving state determination unit 113 determines the moving state, the normal moving pattern update unit 119 adds the determined moving state to the position list corresponding to the time of detecting the movement of the user, calculates the average position of the position list corresponding to the time of detection and updates the normal moving pattern. The normal moving pattern update unit 119 regularly updates the normal moving pattern.

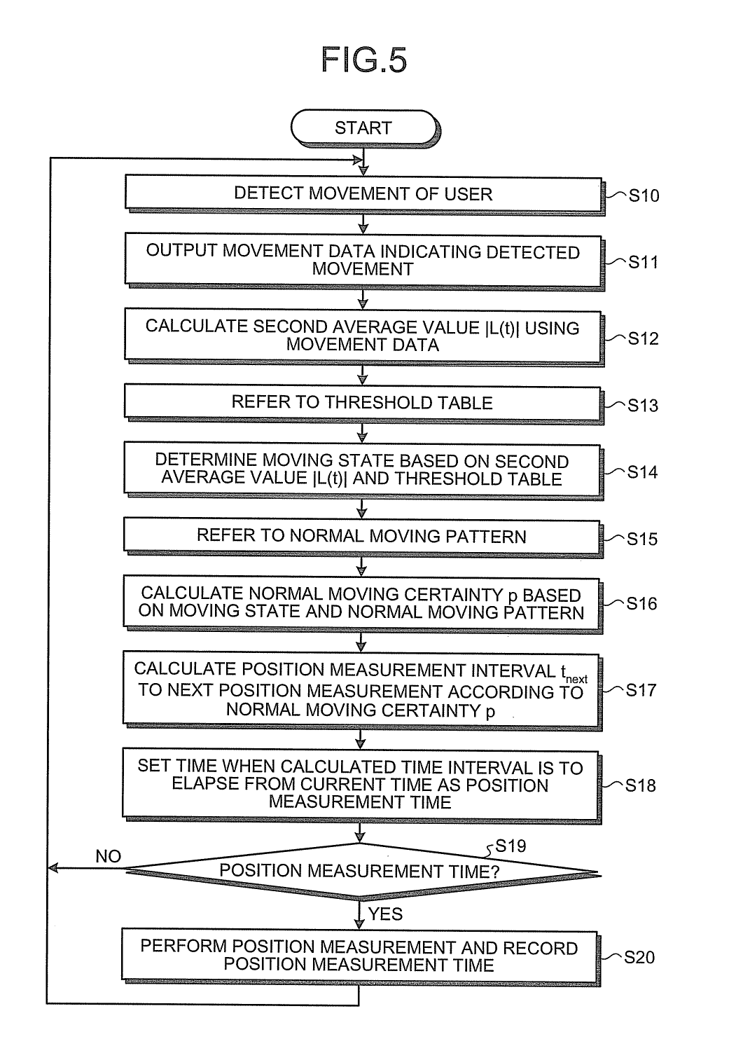

A position measurement interval control processing performed by the portable terminal 100 according to this embodiment configured as stated above will next be described with reference to FIG. 5.

First, the body movement sensor 102 detects the movement of the user who owns the portable terminal 100 (Step S10). The movement data output unit 112 outputs the movement data indicating the movement detected by the body movement sensor 102 based on the detected movement (Step S11).

The moving state determination unit 113 calculates the second average value |L(t)| according to the Equations (1) and (2) using the output movement data (Step S12). The moving state determination unit 113 then refers to the threshold table (FIG. 3) stored in the threshold table storage unit 150 (Step S13). The moving state determination unit 113 determines the moving state of the user who owns the portable terminal 100 to be the moving state corresponding to the range from the minimum value to the maximum value to which the second average value |L(t)| corresponds based on the calculated second average value |L(t)| and the threshold table (Step S14).

Next, the normal moving certainty calculation unit 114 refers to the normal moving pattern stored in the normal moving pattern storage unit 160 (Step S15). The normal moving certainty calculation unit 114 calculates the normal moving certainty p according to the Equations (3) to (7) based on the temporal moving state of the user determined by the moving state determination unit 113 and the normal moving pattern to which the normal moving certainty calculation unit 114 has referred (Step S16).

The position measurement interval controller 115 calculates the position measurement interval tₙₑₓₜ that is the time interval to the next position measurement according to the Equation (8) based on the calculated normal moving certainty p, that is, using the normal moving certainty p, the maximum position measurement interval tₘₐₓ that is the longest position measurement interval for the position measurement performed by the positioning unit 111 and the minimum position measurement interval tₘᵢₙ that is the shortest position measurement interval (Step S17). The position measurement interval controller 115 sets a time when the calculated position measurement interval tₙₑₓₜ is to elapse from current time as the position measurement time (Step S18).

The positioning unit 111 determines whether or not there comes the set position measurement time (Step S19). If it is not the set position measurement time (Step S19: No), the positioning unit 111 does not perform position measurement and returns to the Step S10 from the processing is repeated. If there comes the set position measurement time (Step S19: Yes), the positioning unit 111 measures the current position of the user and records the position measurement time (Step S20). Thereafter, the processing returns to the Step S10 from which the processing is repeated.

In this way, the portable terminal 100 according to this embodiment can calculate the normal moving certainty p indicating a degree of coincidence between the moving state of the user determined using the body movement sensor 102, which consumes lower power consumption than the GPS function, and the normal moving pattern, and calculate the position measurement interval for the position measurement performed by the positioning unit 111 using the GPS function depending on the calculated normal moving certainty. That is, if the value of the normal moving certainty is high, it is more probable that the user is moving according to the normal moving pattern, and thus, the position measurement interval for position measurement performed by the positioning unit 111 is lengthened, so that the pace of the operation performed by the positioning unit 111 can be decreased. It is, therefore, possible to perform position measurement with reduced power consumption and to grasp whether or not the user is moving according to the normal moving pattern.

### Second Embodiment

The portable terminal according to the first embodiment determines the moving state of the user using the body movement sensor, and calculates the normal moving certainty based on the moving state and the normal moving pattern so as to calculate the position measurement interval. A portable terminal according to a second embodiment, by contrast, estimates a current position of a user who owns the portable terminal based on a previously measured position, the previous measurement time, and the like, calculates a degree of coincidence between the estimated current position and an actual current position and calculates a position measurement interval. Since an external configuration of the portable terminal according to this embodiment is similar to that of the portable terminal according to the first embodiment shown in FIG. 1, it will not be described herein.

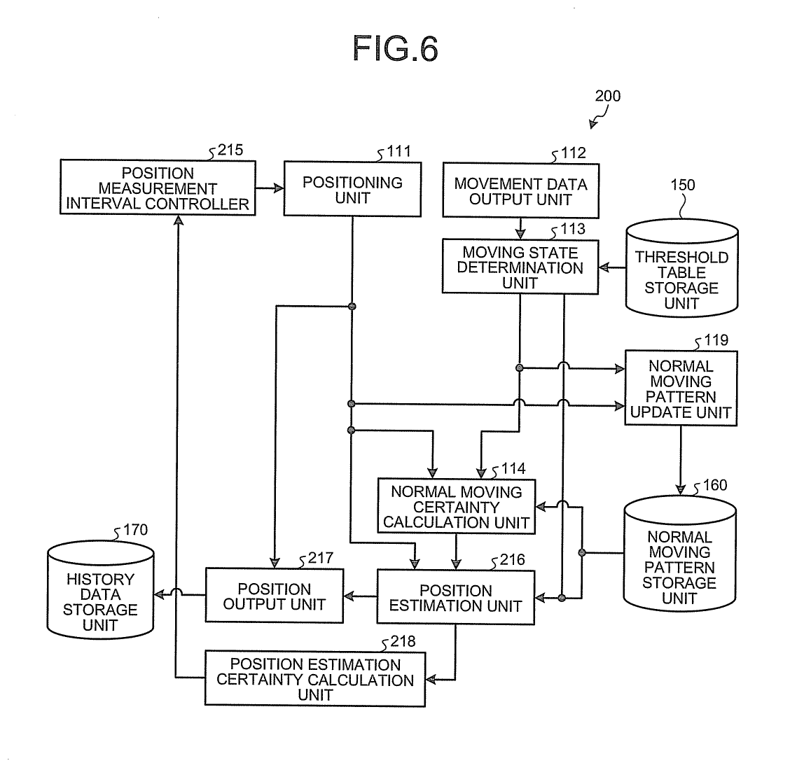

As shown in FIG. 6, a portable terminal 200 mainly includes the positioning unit 111, the movement data output unit 112, the moving state determination unit 113, the threshold table storage unit 150, the normal moving certainty calculation unit 114, the normal moving pattern storage unit 160, a position measurement interval controller 215, the normal moving pattern update unit 119, a position estimation unit 216, a position output unit 217, a position estimation certainty calculation unit 218 and a history data storage unit 170. Since the positioning unit 111, the movement data output unit 112, the moving state determination unit 113, the threshold table storage unit 150, the normal moving certainty calculation unit 114, the normal moving pattern storage unit 160 and the normal moving pattern update unit 119 are similar in configuration and function to those according to the first embodiment shown in FIG. 2, they will not be repeatedly described herein.

The history data storage unit 170 is a storage medium such as a HDD or a memory storing history data on the current position of the portable terminal 200 output from the position output unit 217 to be described later.

The position estimation unit 216 estimates the current position of the portable terminal 200 based on the previously measured position and the previous measurement time by the positioning unit 111, a normal moving pattern stored in the normal moving pattern storage unit 160, a normal moving certainty calculated by the normal moving certainty calculation unit 114 and a moving state determined by the moving state determination unit 113. In other words, the position estimation unit 216 estimates an amount of displacement from a position, which the positioning unit 111 last measured, based on the moving state and the normal moving pattern. Methods of estimating the current position of the portable terminal 200 (“estimation methods”) will be described.

First, the history data on the current position of the portable terminal 200 output from the position output unit 217, to be described later, is stored in the history data storage unit 170. The position estimation unit 216 estimates the current position of the portable terminal 200 using the following estimation methods (A) to (D) according to elapsed time period since the positioning unit 111 last measured the current position of the portable terminal 200.

(A) If elapsed time period t since the positioning unit 111 last measured the current position of the portable terminal 200 is shorter than predetermined time period t1 (t<t1), the position estimation unit 216 estimates the current position of the portable terminal 200 to be the last measured position. That is, if the elapsed time period t since the positioning unit 111 last measured the current position of the portable terminal 200 is short or is shorter than the predetermined time period t1, the position estimation unit 216 considers that a movement of the user from the last measured position is small and estimates the current position of the portable terminal 200 to be the last determined position.

(B) If the elapsed time period t since the positioning unit 111 last measured the current position of the portable terminal 200 is equal to or longer than the predetermined time period t1 and shorter than predetermined time period t2 (t1≦t<t2), the position estimation unit 216 estimates the current position of the portable terminal 200 according to the following Equation (9) based on the measurement time t1 at which the positioning unit 111 last determined the current position of the portable terminal 200 and measurement time t0 at which the positioning unit 111 measured the current position of the portable terminal 200 one time before the last measurement.

Locₑₛₜᵢₘₐₜₑ=Loc₀+(Loc−Loc₀)*(t/(t1−t0)) (9)

In the Equation (9), Loc represents the position of the portable terminal 200 that the positioning unit 111 last measured and Loc₀ represents the position of the portable terminal 200 that the positioning unit 111 measured one time before the last measurement.

That is, according to the Equation (9), if the elapsed time period t since the positioning unit 111 last measured the current position of the portable terminal 200 is long or is equal to or longer than the predetermined time period t1, which is a reference to use the method (A), but is shorter than the predetermined time period t2, which is a reference to use a method (C) to be described later, the position estimation unit 216 considers that the user is moving at the same velocity as that at which the user moves a distance (Loc−Loc₀) from the positioning of one time before to the last positioning for time period (t1−t0) and estimates the current position of the portable terminal 200.

(C) If the elapsed time period t since the positioning unit 111 last measured the position is equal to or longer than the predetermined time period t2 and a normal moving certainty p is equal to or higher than a predetermined value T (t2≦t, T≦p), the position estimation unit 216 estimates the current position to be a position (a longitude and a latitude) corresponding to current time in the normal moving pattern stored in the normal moving pattern storage unit 160. That is, in this case, the normal moving certainty p is a high value or is equal to or higher than the predetermined value T and thus it can be assumed that the user is moving without largely deviating from the normal moving pattern. Therefore, the position estimation unit 216 estimates the current position to be the position corresponding to the current time in the normal moving pattern.

(D) If the elapsed time period t since the positioning unit 111 last measured the current position is equal to or longer than the predetermined time period t2 and the normal moving certainty p is lower than the predetermined value T (t2≦t, T>p), the position estimation unit 216 estimates the current position based on moving histories recorded so far according to the following Equation (10) using an estimated moving velocity v_{act} based on the moving state determined by the moving state determination unit 113.

Locₑₛₜᵢₘₐₜₑ=Loc+(Loc−Loc₀)/(t−t₀)*V_{act}*t (10)

In the Equation (10), v_{act} is the estimated moving velocity defined in advance depending on a content of each moving state for every moving state. In this embodiment, the estimated moving velocity v_{act} is stored in a memory or the like in advance.

That is, if the elapsed time period t since the last positioning is long or is equal to or longer than t2 and the normal moving certainty p is not so high or is lower than the predetermined value T, it can be assumed that the user is moving while deviating from the normal moving pattern at a position away from the position of the last measurement. Therefore, the position estimation unit 216 estimates the current position based on not only the moving velocity for the time period (t1−t0) from the position measurement one time before the last position measurement to the last position measurement but also the estimated moving velocity v_{act}.

The position estimation certainty calculation unit 218 calculates a position estimation certainty q based on the elapsed time period since the positioning unit 111 last measured the current position and the moving state certainty p according to the estimation method by which the position estimation unit 216 estimates the current position of the portable terminal 200. The position estimation certainty q means herein a degree of coincidence between the current position of the user estimated by the position estimation unit 216 and the actual current position of the user who owns the portable terminal 200. A specific method of calculating the moving state certainty q will be described.

The position estimation certainty calculation unit 218 calculates the position estimation certainty q according to one of the following Equations (11) depending on either one of the estimation methods (A), (B), (C) and (D) stated above is used when the position estimation unit 216 estimates. In the Equations (11), p represents the normal moving certainty calculated in the first embodiment.

$$\begin{matrix}\begin{matrix}\begin{matrix}In case of ( A ) \text{:} q = 1 \\ In case of ( B ) \text{:} q = 0.7\end{matrix} \\ In case of ( C ) \text{:} q = 0.3 + 0.4 ⋆ P\end{matrix} \\ In case of ( D ) \text{:} q = 0.3 ⋆ t 2 / t\end{matrix} \} \qquad ( 11 )$$

That is, if the estimation method (A) is adopted and the elapsed time period t since the positioning unit 111 last measured the current position is shorter than the predetermined time period t1, the position estimation certainty calculation unit 218 determines that the estimated current position does not largely differ from the actual current position, and thus sets the position estimation certainty q to a maximum value, that is, q=1.

If the estimation method (B) is adopted, the position estimation unit 216 considers that the user is moving at the same velocity as that at which the user moves the distance (Loc−Loc₀) from the positioning of one time before the last position measurement to the last position measurement for the time period (t1−t0) and estimates the current position of the portable terminal 200. Therefore, the position estimation certainty calculation unit 218 sets the position estimation certainty q to a relatively high value.

If the estimation method (C) is adopted, it can be assumed that the user is moving without largely deviating from the normal moving pattern based on the normal moving certainty p, and thus the position estimation unit 216 estimates the current position to be the position corresponding to the current time in the normal moving pattern. Therefore, the position estimation certainty calculation unit 218 calculates the position estimation certainty q depending on the value of the normal moving certainty p.

If the estimation method (D) is adopted, the position estimation unit 216 estimates the current position also considering the estimated moving velocity v_{act}. However, it is also highly likely that the estimated current position is away from an actual current position. Therefore, the position estimation certainty calculation unit 218 calculates the position estimation certainty q to be a relatively low value in view of the elapsed time period t and the predetermined time period t2.

In this way, according to this embodiment, the position estimation certainty calculation unit 218 calculates the position estimation certainty q according to the estimation methods by which the position estimation unit 216 estimates the current position. The position measurement interval controller 215 can thereby control the position measurement interval according to the respective position estimation certainties q.

The position output unit 217 displays the estimated current position of the portable terminal 200 on a display unit (not shown) if the position estimation unit 216 estimates the current position of the portable terminal 200 and the positioning unit 111 does not perform position measurement. If the positioning unit 111 performs the position measurement, the position output unit 217 displays the measured actual current position of the portable terminal 200 on the display unit even if the position estimation unit 216 estimates the current position of the portable terminal 200.

The position measurement interval controller 215 calculates the position measurement interval for the position measurement performed by the positioning unit 111 according to the position estimation certainty q calculated by the position estimation certainty calculation unit 218. More specifically, the position measurement interval controller 215 calculates a longer position measurement interval as the value of the position estimation certainty q is higher. That is, as the degree of coincidence between the current position estimated by the position estimation unit 216 and the actual current position of the user who owns the portable terminal 200 is higher and the value of the position estimation certainty q is higher, it is more probable that the user is moving according to the normal moving pattern. Therefore, the position measurement interval controller 215 lengthens the position measurement interval for the position measurement performed by the positioning unit 111 to decrease the pace of the operation.

On the other hand, as the degree of coincidence between the current position estimated by the position estimation unit 216 and the actual current position of the user who owns the portable terminal 200 is lower and the value of the position estimation certainty q is lower, it is more probable that the user is moving without following the normal moving pattern. Therefore, the position measurement interval controller 215 shortens the position measurement interval for the position measurement performed by the positioning unit 111 to increase the pace of the operation.

Specifically, the position measurement interval controller 215 calculates a time interval to next position measurement (position measurement interval) t next using the position estimation certainty q according to the following Equation (12).

tₙₑₓₜ=q*(tₘₐₓ−tₘᵢₙ)+tₘᵢₙ (12)

In the Equation (12), tₘₐₓ represents a maximum position measurement interval that is a longest position measurement interval for the position measurement performed by the positioning unit 111 and tₘᵢₙ represents a minimum position measurement interval that is a shortest position measurement interval for the position measurement performed by the positioning unit 111. That is, as expressed by the Equation (12), the position measurement interval controller 215 calculates the time interval to the next position measurement (position measurement interval) tₙₑₓₜ by multiplying a difference between the maximum position measurement interval tₘₐₓ and the minimum position measurement interval tₘᵢₙ by the position estimation certainty q and adding the multiplication result to the minimum position measurement interval tₘᵢₙ.

The position measurement interval controller 215 sets a time when the calculated position measurement interval tₙₑₓₜ is to elapse from current time in the memory or the like as position measurement time similarly to the first embodiment. When there comes the position measurement time set in the memory or the like, the positioning sensor 101 and the positioning unit 111 start position measurement to receive radio waves from the GPS satellite and the positioning unit 111 measures the current position of the portable terminal 200.

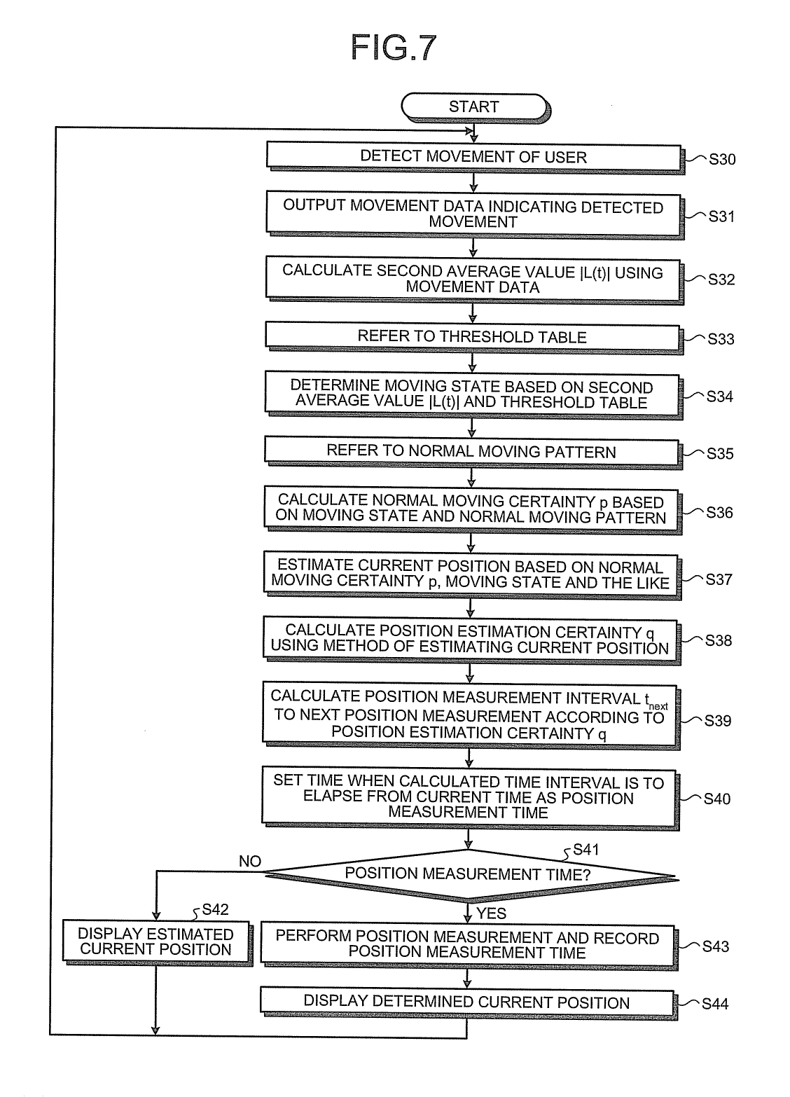

A position measurement interval control processing performed by the portable terminal 200 according to this embodiment configured as stated above will next be described with reference to FIG. 7.

First, since processing steps from a step in which the body movement sensor 102 detects the movement of the user to a step in which the normal moving certainty calculation unit 114 calculates the normal moving certainty (Steps S30 to S36) are similar to the processing steps according to the first embodiment (Steps S10 to S16), the steps S30 to S36 will not be described herein.

The position estimation unit 216 estimates the current position of the portable terminal 200 using the previously measured position, the previous measurement time, the normal moving pattern, the normal moving certainty and the moving state using one of the abovementioned estimation methods (A) to (D) according to the elapsed time period since the positioning unit 111 last performed the position measurement. If the position estimation unit 216 estimates the current position by the estimation method (B), the Equation (9) is used. If the position estimation unit 216 estimates the current position according to the estimation method (D), the Equation (10) is used (Step S37).

The position estimation certainty calculation unit 218 calculates the position estimation certainty q using one of the Equations (11) according to the estimation method (one of the estimation methods (A), (B), (C) and (D)) by which the position estimation unit 216 estimates the current position (Step S38).

The position measurement interval controller 215 calculates the position measurement interval tₙₑₓₜ that is the time interval to the next position measurement according to the Equation (12) based on the calculated position estimation certainty q, that is, using the maximum position measurement interval tₘₐₓ that is the longest position measurement interval for the position measurement performed by the positioning unit 111 and the minimum position measurement interval tₘᵢₙ, that is the shortest position measurement interval (Step S39). The position measurement interval controller 215 sets a time when the calculated position measurement interval tₙₑₓₜ is to elapse from current time as the positioning time (Step S40).

The positioning unit 111 determines whether or not there comes the set position measurement time (Step S41). If it is not the set position measurement time (Step S41: No), the positioning unit 111 does not perform position measurement and the position output unit 217 displays the estimated current position of the portable terminal 200 on the display unit (Step S42). Thereafter, the processing returns to the Step S30 from which the processing is repeated.

If there comes the set position measurement time (Step S41: Yes), the positioning unit 111 measures the current position the user and records the position measurement time (Step S43). Next, the position output unit 217 displays the measured actual current position of the portable terminal 200 on the display unit (Step S44). Thereafter, the processing returns to the Step S30 from which the processing is repeated.

In this way, the portable terminal 200 according to this embodiment can estimate the current position of the portable terminal 200 based on the previously measured position, the previous measurement time and the like, calculate the position estimation certainty indicating a degree of coincidence between the estimated current position and the actual current position of the user who owns the portable terminal 200, and set the position measurement interval for the position measurement performed by the positioning unit 111 using the GPS function according to the calculated position estimation certainty. That is, if the value of the position estimation certainty is high, it is highly probable that the user is moving according to the normal moving pattern. Therefore, the position measurement interval for the position measurement performed by the positioning unit 111 can be lengthened, so that the operation pace can is decreased. It is, therefore, possible to perform position measurement with reduced power consumption and to grasp whether or not the user is moving according to the normal moving pattern.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A positioning device comprising:
a detection unit configured to detect a movement of a user who owns the positioning device;
a storage unit configured to store, in advance, a normal moving pattern indicating a temporal change in a moving state of the user at normal time;
a determination unit configured to determine the moving state from the movement;
a first certainty calculation unit configured to calculate a first certainty indicating a degree of coincidence between the normal moving pattern and the moving state determined at time of detecting the movement;
an interval calculation unit configured to calculate a position measurement interval depending on the first certainty; and
a positioning unit configured to measure a current position of the positioning device at the position measurement interval.

2. The positioning device according to claim 1,
wherein the first certainty calculation unit calculates the first certainty based on the normal moving pattern and the temporal change in the moving state determined by the determination unit.

3. The positioning device according to claim 1,
wherein the interval calculation unit calculates the position measurement interval that is longer as the first certainty is higher.

4. The positioning device according to claim 1,
wherein the interval calculation unit calculates the position measurement interval to next position measurement depending on the first certainty, a maximum interval that is a longest position measurement interval and a minimum interval that is a shortest position measurement interval.

5. The positioning device according to claim 4,
wherein the interval calculation unit calculates the position measurement interval to the next position measurement by multiplying a difference between the maximum interval and the minimum interval by the first certainty and adding time period obtained by the multiplication to the minimum interval.

6. The positioning device according to claim 1, further comprising:
an estimation unit configured to estimate the current position of the positioning device; and
a second certainty calculation unit configured to calculate a second certainty based on elapsed time period since last position measurement time and the first certainty, the second certainty indicating a degree of coincidence between the current position and an actual current position of the user who owns the positioning device
wherein the interval calculation unit calculates the position measurement interval also depending on the second certainty.

7. The positioning device according to claim 6,
wherein the estimation unit estimates the current position of the positioning device from a previously measured position, a previous measurement time, the normal moving pattern and the first certainty.

8. The positioning device according to claim 6,
wherein the interval calculation unit calculates the position measurement interval that is longer as the second certainty is higher.

9. The positioning device according to claim 6, further comprising:
an output unit configured to output the current position.

10. The positioning device according to claim 6,
wherein the interval calculation unit calculates the position measurement interval to next position measurement depending on the second certainty, a maximum interval that is a longest position measurement interval and a minimum interval that is a shortest position measurement interval.

11. The positioning device according to claim 10,
wherein the interval calculation unit calculates the position measurement interval to the next position measurement by multiplying a difference between the maximum interval and the minimum interval by the second certainty and adding time period obtained by the multiplication to the minimum interval.

12. A position measurement interval control method comprising:
detecting a movement of a user who owns a positioning device;
determining a moving state of the user who owns the positioning device from the movement;
calculating a first certainty indicating a degree of coincidence between the normal moving pattern and the moving state determined at time of detecting the movement;
calculating a position measurement interval depending on the first certainty; and
measuring a current position of the positioning device at the position measurement interval.
